(19) United States
(12) Patent Application Publication
(10) Pub. No.: US 2026/0141225 A1
(43) Pub. Date: May 21, 2026

(54) PROMPT RECOMMENDATIONS FOR AI ENGINES

(71) Applicant: Kyndryl, Inc., New York, NY (US)

(72) Inventor: Manish Gupta, New Delhi (IN)

(21) Appl. No.: 18/951,744

(22) Filed: Nov. 19, 2024

(51) Int. Cl. G06N 3/0475

(52) U.S. Cl. CPC G06N 3/0475

(57) ABSTRACT

Embodiments relate to providing prompt recommendations for artificial intelligence (AI) engines. Aspects include determining that a received prompt is in a cluster, the cluster having a representative prompt and generating candidate prompts based on the representative prompt. Aspects include ranking the candidate prompts to determine a selected candidate prompt from the candidate prompts; and presenting the selected candidate prompt to be input for an AI engine.

### BACKGROUND

The present invention generally relates to computer systems, and more specifically, to computer-implemented methods, computer systems, and computer program products configured and arranged to provide prompt recommendations for artificial intelligence (AI) engines.

AI is in the field of computer science relating to the development of computer systems for performing tasks that typically require human intelligence, such as speech recognition, natural language processing (NLP), text generation and translation, video, sound, and image generation, decision making, planning, and more. In general, AI refers to the development of intelligent systems that can mimic human behavior and decision-making processes. AI encompasses techniques and approaches enabling machines to perform tasks, analyze visual and textual data, and respond or adapt to their environment. One of the benefits of artificial intelligence is its ability to process large amounts of data and find patterns in it. As such, AI tools are designed to make decisions or take actions based on that knowledge.

An AI prompt may be a question, command, or statement used to interact between a human and the AI model such as a large language model that allows the AI model to produce the intended output. The purpose of the prompt is to provide the AI model with enough information so that it can produce output relevant to the prompt.

### SUMMARY

Embodiments of the present invention are directed to computer-implemented methods for providing prompt recommendations for artificial intelligence (AI) models. A non-limiting computer-implemented method includes determining that a received prompt is in a cluster, the cluster having a representative prompt. The method includes generating candidate prompts based on the representative prompt and ranking the candidate prompts to determine a selected candidate prompt from the candidate prompts. The method includes presenting the selected candidate prompt to be input for an artificial intelligence (AI) engine.

According to one or more embodiments, a computer-implemented method includes capturing a user prompt and anonymizing the user prompt. The method includes determining a cluster for the user prompt, the cluster having a representative prompt that represents the user prompt. The method includes generating candidate prompts for the representative prompt in accordance with association rules determined for previous transactions of a plurality of representative prompts and ranking the candidate prompts to determine a selected candidate prompt from the candidate prompts. The method includes presenting the selected candidate prompt to be input for an artificial intelligence (AI) engine.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system configured to provide prompt recommendations for artificial intelligence (AI) engines, by determining a new prompt to recommend, presenting the new prompt to the user, and causing the recommended new prompt to be executed by AI engines according to one or more embodiments of the present invention;

FIG. 3 depicts a flowchart of a computer-implemented method for dynamically generating prompt recommendations for AI engines according to one or more embodiments of the present invention;

FIG. 4 depicts an example of utilizing past representative prompts to determine association rules and predict candidate prompts for a user according to one or more embodiments of the present invention;

FIG. 5 depicts a block diagram of example subcomponents for generating prompt recommendations for AI engines according to one or more embodiments of the present invention;

FIG. 6 depicts a block diagram of an example using a metaprompt for determining a personal applicability/relevance value for a candidate prompt according to one or more embodiments of the present invention;

FIG. 7 depicts a block diagram of an example using a metaprompt for determining a personal applicability/relevance value for a candidate prompt according to one or more embodiments of the present invention;

FIG. 8 depicts a block diagram of an example using a metaprompt for determining a personal applicability/relevance value for a candidate prompt according to one or more embodiments of the present invention;

FIG. 9 depicts a flowchart of a computer-implemented method for dynamically providing prompt recommendations for AI engines according to one or more embodiments of the present invention;

FIG. 10 depicts a flowchart of a computer-implemented method for dynamically providing prompt recommendations for AI engines according to one or more embodiments of the present invention;

FIG. 11 depicts a cloud computing environment according to one or more embodiments of the present invention; and

FIG. 12 depicts abstraction model layers according to one or more embodiments of the present invention.

### DETAILED DESCRIPTION

One or more embodiments are configured and arranged to dynamically recommend prompts for artificial intelligence (AI) engines. Upon acceptance or selection of the recommended prompt, one or more embodiments can cause the prompt to be executed by AI engines on behalf of a user. The output of the AI engines are presented to the user.

With the incorporation of artificial intelligence in the information technology (IT) practices of organizations or enterprises, there may be a desire to leverage prompts from different users. In an example scenario, an organization may wish to share prompts between different employees. Employees of the organization can issue several prompts, but there is no efficient way to share the prompts between users. Also, the prompts from various users may differ; currently, there is no way to account for the many variations in the prompts and how to make recommendations given so many variations. Although many organizations are adopting AI engines for internal and external use, users in an organization could benefit from improved prompts to AI engines.

One or more embodiments are configured to recommend to a user a new prompt (e.g., new prompt Y) after knowing that the user has just executed a previous prompt (e.g., previous prompt X). In one or more embodiments, the new prompt may be recommended based on various prompts entered by different users in the past. Continuing the scenario of employees in an organization, the employees may enter various prompts in a user interface with a prompt capturing function. One or more embodiments may create rules associated with the various captured prompts, use the rules to determine when a new prompt is to be recommended, recommend the new prompt to a user, and cause the recommended prompt to be executed by an AI engine on behalf of the user.

The present disclosure provides various technical effects and technical solutions. By automatically recommending a new prompt to the user, the system provides the user with an improved user experience on the user device even if the user lacks familiarity with prompt creation. Also, the system can automatically execute actions on behalf of the user by inputting the recommended prompt to an AI engine for execution and providing the output of the AI engine to the user. By providing the user with a recommended prompt based on personal data, a previous prompt of the user, and/or prompts made by other users in the organization, this can prevent numerous prompt attempts that fail to generate the appropriate/correct output from the AI engine, thereby reducing computer processor usage (e.g., reducing CPU usage), reducing memory usage, and reducing network bandwidth (e.g., reducing the amount of back and forth communications (and input/output operations) between the user device and the AI engine). Further, technical effects and solutions allow the user to select an interactive user experience on the user device, which anticipates actions/information for the user by recommending prompts for AI engines based on user experience and organization experience.

One or more embodiments described herein can utilize machine learning techniques to perform tasks, such as classifying a feature of interest. More specifically, one or more embodiments described herein can incorporate and utilize rule-based decision making and artificial intelligence reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

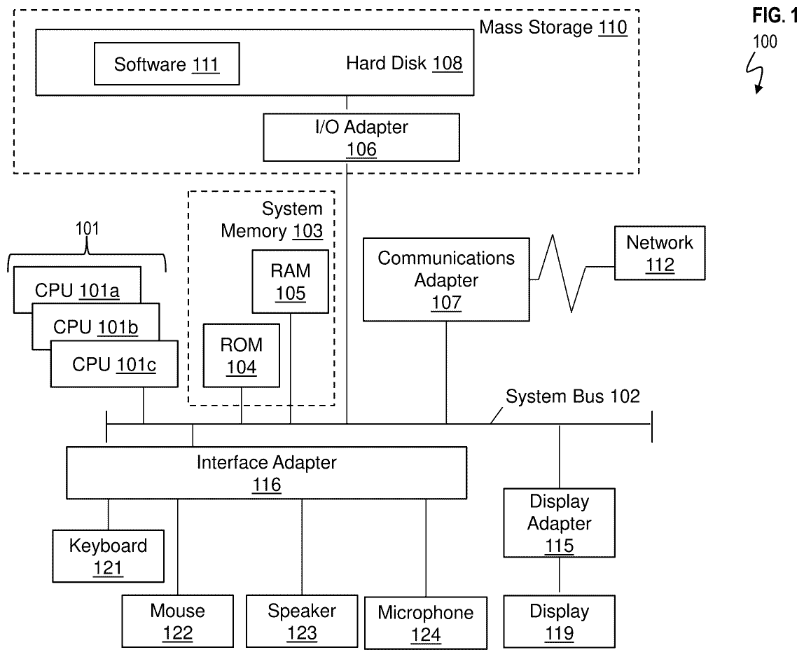

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random-access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program products and the execution of such instruction are discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

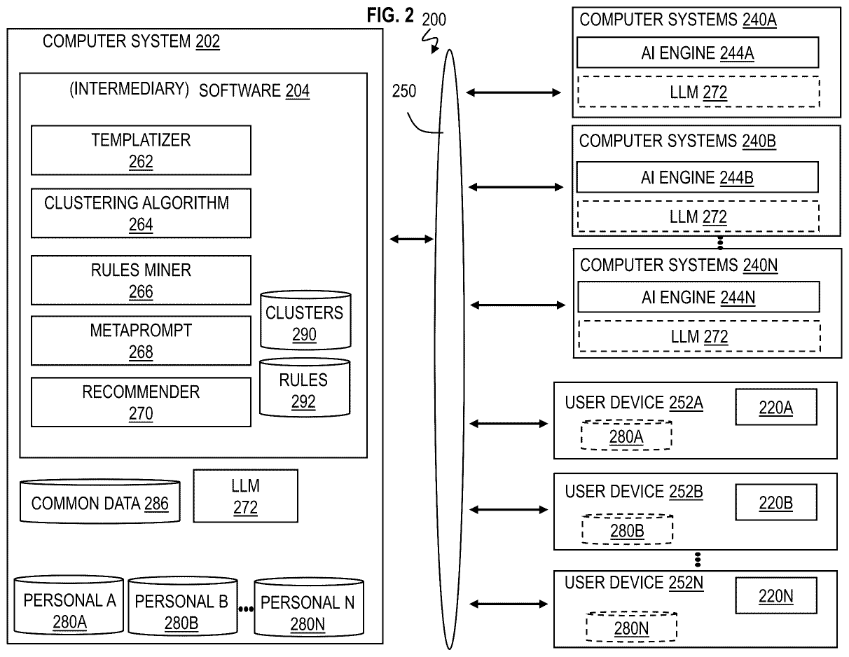

FIG. 2 depicts a block diagram of an example system 200 configured to provide prompt recommendations for artificial intelligence (AI) engines on behalf of a user, by determining a new prompt to recommend, presenting the new prompt to the user, causing the recommended new prompt to be executed by AI engines, and/or presenting the responses of the AI engines to the user. The system 200 includes a computer system 202 configured to communicate over a network 250 with many different computer systems, such as a computer system 240A, a computer system 240B, through a computer system 240N. The computer system 240A, the computer system 240B, through the computer system 240N can generally be referred to as computer systems 240.

The computer system 202 is configured to communicate over the network 250 with various user devices, such as a user device 252A of user A, a user device 252B of user B, through a user device 252N of user N. The user device 252A, the user device 252B, through the user device 252N can generally be referred to user devices 252. The user devices 252 can be a personal computer or laptop. The user devices 252 can be a mobile device such as a cellular phone or tablet or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 250 can be a wired and/or wireless communication network, and the communication network includes a telecommunications network, the public switched telephone network (PTSN), voice over IP (VOIP) network, etc. The communication network includes cellular networks, satellite networks, etc.

The computer systems 240 and user devices 252 can include various software and hardware components including software applications (apps) for communicating over the network 250 as understood by one of ordinary skill in the art. The computer systems 240A, 240B, and 240N can include AI engines 244A, 244B, and 244N, respectively to provide AI services. The AI engines 244A, 244B, and 244N can generally be referred to as AI engines 244. In one or more embodiments, the computer systems 240A, 240B, and 240N and/or the computer system 202 may include a large language model (LLM) 272. The user devices 252A, 252B, and 252N may include its own personal data in respective repositories 280A, 280B, and 280N. The personal data can include emails, documents, calendars, reminders, etc., for respective users A, B, and N. The repositories 280A, 280B, and 280N can generally be referred to as repository 280. In one or more embodiments, the computer system 202 may include repositories 280A, 280B, and 280N for respective users A, B, and N of user devices 252. The user devices 252A, 252B, and 252N can include user software 220A, 220B, and 220N, respectively to capture prompts and recommend new prompts. The user software 220A, 220B, and 220N can generally be referred to as user software 220. In one or more embodiments, the user software 220 may be representative of client software in a server-client relationship. For example, the user software 220 may be a thin client. The user software 220 may include an application installed on the user devices 252 and/or coupled to the user devices 252 for access by users. In one or more embodiments, the user software 220 may include a user interface in which prompts can be input by users for execution by AI engines and new prompts can be recommended to users. The user software 220 may include plugins, portals, webpages, remote connection software, etc., for access by the users in accordance with one or more embodiments. In one or more embodiments, the user selects an option to authorize the user software 220 to execute on the user device 252. The execution of the user software 220 generates an interactive user experience that anticipates actions/information for the user by recommending prompts for AI engines 244 based on prior/current user information (e.g., in repository 280) and organization information (e.g., in repository 286). In one or more embodiments, the user software 220 and/or computer system 202 can automatically input the recommended prompts to the AI engines 244 and provide the output to the user.

The computer system 202, computer systems 240, user devices 252, software 204, user software 220, etc., can include functionality and features of the computer system 100 in FIG. 1 including various hardware components and various software applications such as software 111 which can be executed as instructions on one or more processors 101 in order to perform actions according to one or more embodiments of the invention. The software 204 and user software 220 can include, be integrated with, and/or call other pieces of software, algorithms, application programming interfaces (APIs), graphical user interfaces (GUIs), etc., to operate as discussed herein.

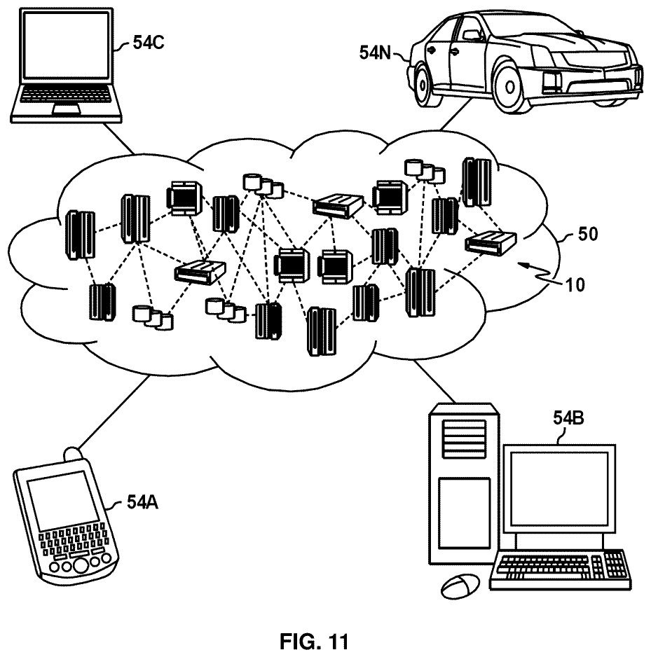

The computer system 202 may be representative of numerous computer systems and/or distributed computer systems configured to provide AI prompt recommendation services to users of the computer systems 240. The computer system 202 can be part of a cloud computing environment such as a cloud computing environment 50 depicted in FIG. 11, as discussed further herein.

AI engines may use generative artificial intelligence which is a type of AI that can create new content and ideas, including conversations, stories, images, videos, and music. AI technologies attempt to mimic human intelligence in nontraditional computing tasks like image recognition, natural language processing (NLP), and translation. AI engines are trained to learn human language, programming languages, art, chemistry, biology, or any complex subject matter. AI engines reuse training data to solve new problems. An organization can use AI engines for various purposes. Like any artificial intelligence, an AI engine works by using machine learning models such as very large models that are pretrained on vast amounts of data. Examples of very large models can include foundation models and large language models.

Foundation models: Foundation models (FMs) are machine learning models trained on a broad spectrum of generalized and unlabeled data. Foundation models are capable of performing a wide variety of general tasks. Foundation models are the result of the latest advancements in a technology that has been evolving for decades. In general, a foundational model uses learned patterns and relationships to predict the next item in a sequence. For example, with image generation, the foundational model analyzes the image and creates a sharper, more clearly defined version of the image. Similarly, with text, the foundational model predicts the next word in a string of text based on the previous words and their context. The foundational model then selects the next word using probability distribution techniques.

Large language models: Large language models (LLMs) are one class of foundational models. LLMs are specifically focused on language-based tasks such as such as summarization, text generation, classification, open-ended conversation, and information extraction.

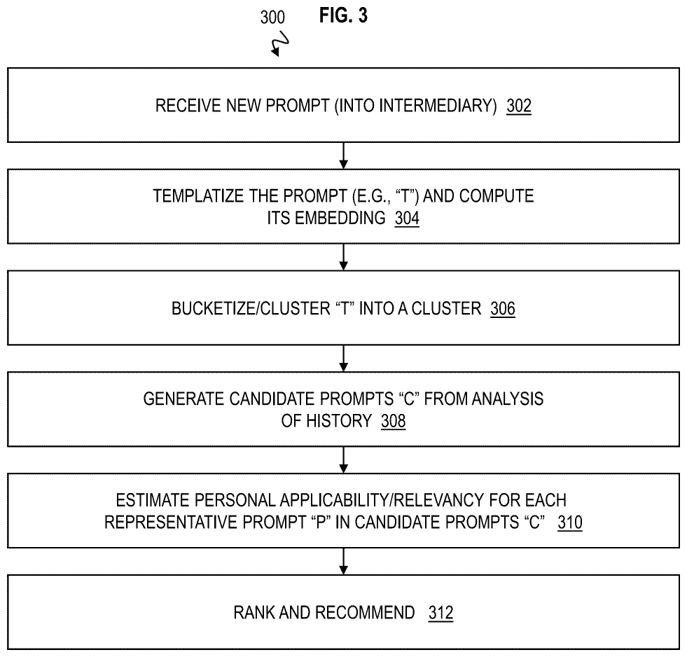

FIG. 3 depicts a flowchart of a computer-implemented method 300 for providing prompt recommendations for artificial intelligence engines on behalf of a user, by determining a new prompt to recommend, presenting the new prompt to the user, causing the recommended new prompt to be executed by AI engines, and/or presenting the responses of the AI engines to the user according to one or more embodiments.

At block 302 of the computer-implemented method 300, the software 204 is configured to receive prompts being created by users. Whenever a user sends a prompt, the prompt is captured by an intermediary such as the software 204 according to one or more embodiments. In one or more embodiments, the user device 252 can push the user prompt to the software 204, and/or the software 204 can pull the user prompt from the user device 252. For example, a user of a user device 252 may send a prompt and/or select to send the prompt to an AI engine 244. The software 204 receives the prompt sent to the AI engine 244. In one or more embodiments, the user software 220 may send or push the prompt to the software 204 concurrently with, nearly concurrently with, or prior to sending the prompt to the AI engine 244. In one or more embodiments, the user software 220 can cause the prompt to be intercepted and sent to the software 204, which can then send the prompt to the AI engine 244. In one or more embodiments, a copy of the prompt is sent from the user software 220 to the software 204. According to embodiments, the software 204 receives numerous prompts from different users of user devices 252 for further processing as discussed herein. The collection of these various prompts can be utilized to generate association rules as discussed herein.

At block 304, for each user prompt, the software 204 is configured to templatize the prompt into a template (“T”) and compute the embedding for the templatized prompt (T). The software 204 can anonymize the prompt by removing personal or private information. The software 204 may call, employ, and/or include a templatizer 262 for removing personal or private information. In one or more embodiments, the software 204 can employ a Spacy module for named entity recognition (NER) to identify any personal information and templatize the prompt by removing the personal information and any other information that makes the prompt specific to a user. In one or more embodiments, the software 204 can employ or use a foundational model (e.g., LLM 272) for templatization as well as computing its vector embedding.

When computing the embedding, the software 204 causes the anonymized prompt, which is the templatized prompt T, to be converted into a numerical vector. The software 204 can call or employ any known technique, algorithm, AI model, etc., for computing vector embeddings for the prompts. Example techniques and algorithms for vector embedding may include Word2Vec (which uses Continuous Bag-Of-Words (CBOW) and Skip-gram), GloVe (which stands for Global Vectors), etc. Example AI models for computing vector embeddings may include RNNs, transformer-based models, etc. Any suitable vector embedding techniques may be utilized.

At block 306, for each templatized prompt (T), the software 204 is configured to bucketize the templatized prompt (T) into a cluster. As noted herein, the templatized prompt has been anonymized and vectorized. The software 204 may call or employ a clustering algorithm 264 that is used to arrange the templatized prompts into different groups or clusters (e.g., buckets) in such a manner that the templatized prompts in the same cluster are more similar to each other than the templatized prompts in any other cluster. As discussed herein, the templatized prompts are embedded vectors, and each templatized prompt is put into a cluster such that there can be numerous clusters.

In one or more embodiments, N-means clustering (or K-Means) can be utilized to create clusters of the templatized prompts, where the N increases as the variety in prompts increases. Also, examples of clustering algorithms may include spectral clustering, DBSCAN (which stands for density-based spatial clustering of applications with noise), affinity propagation, hierarchical clustering, MeanShift, etc. Any suitable clustering algorithm may be utilized.

At block 308, the software 204 is configured to generate candidate prompts (“C”) for a given user from the analysis of the history of different user prompts. Each cluster of the templatized prompts (T) has a representative prompt (“P”) for that cluster. For example, if there are 1000 clusters, then there are correspondingly 1000 representative prompts (P) representing its respective cluster. The representative prompt (P) for a cluster may be an equal distance from the other templatized prompts (T) in that cluster. For example, the representative prompt (P) for a cluster may be determined to have an equal distance in that cluster based on a semantic distance, a Euclidean distance, cosine similarity, etc., and/or any suitable clustering algorithm/technique. The various clusters and their representative prompts (P) may be stored in a repository 290 of clusters.

Using the cluster representative prompts (P) for all of the clusters in the repository 290, the software 204 is configured to determine association rules associated with representative prompts (P). There can be numerous users with their past history of templatized prompts, where the cluster representative prompts (P) are captured in the dataset. The association rules may be stored in a repository 292. The software 204 may call or employ an association rules miner 266 to determine rules based on temporally close occurrences of prompt executions, which are considered transactions. Association rules may be if-then statements that show the probability of relationships between data items (e.g., representative prompts (P)) within large datasets in various types of databases. In one or more embodiments, association rule mining by the association rules miner 266 can involve the use of machine learning models to analyze data for patterns, called co-occurrences, in a database. The association rules miner 266 can identify frequent if-then associations, which themselves are the association rules stored in the repository 292.

Based on a given templatized prompt (T) that represents a prompt just entered by a user, the software 204 can use the association rules miner 266 to determine candidate prompts (C) to recommend to the user in accordance with the prompt just entered/executed by a user for an AI engine. A transaction includes the combination of two or more prompts temporally occurring successively in time within a predefined time window. The candidate prompts (C) represent the next or predicted templatized prompt (T) for the given user, after the user has entered a previous user prompt (e.g., which is anonymized and vectorized to a templatized prompt). A transaction can be two or more successive prompts occurring within the predefined time window, where an example predefined time window may be within seconds (e.g., within 15 seconds, 30 seconds, 45 seconds, 60 seconds, etc.), minutes (e.g., within 1 minute, 2 minutes, 3 minutes, 5 minutes, 10 minutes, 15 minutes, 30 minutes), hours (e.g., within 1 hour, 2 hours, etc.), etc.

In association rule mining, support and confidence are two metrics used to evaluate the strength and relevance of association rules. Support measures the relative frequency of an item (e.g., a representative prompt (P)) in a dataset and indicates how often an item appears in the transactions. Support may be calculated using the example formula: Support (X)=(Number of transactions containing X)/(Total number of transactions). Confidence measures the reliability of an association rule and indicates the proportion of cases in which the rule holds true. Confidence may be calculated using the example formula: Confidence (X=>Y)=(Number of transactions containing X and Y)/(Number of transactions containing X).

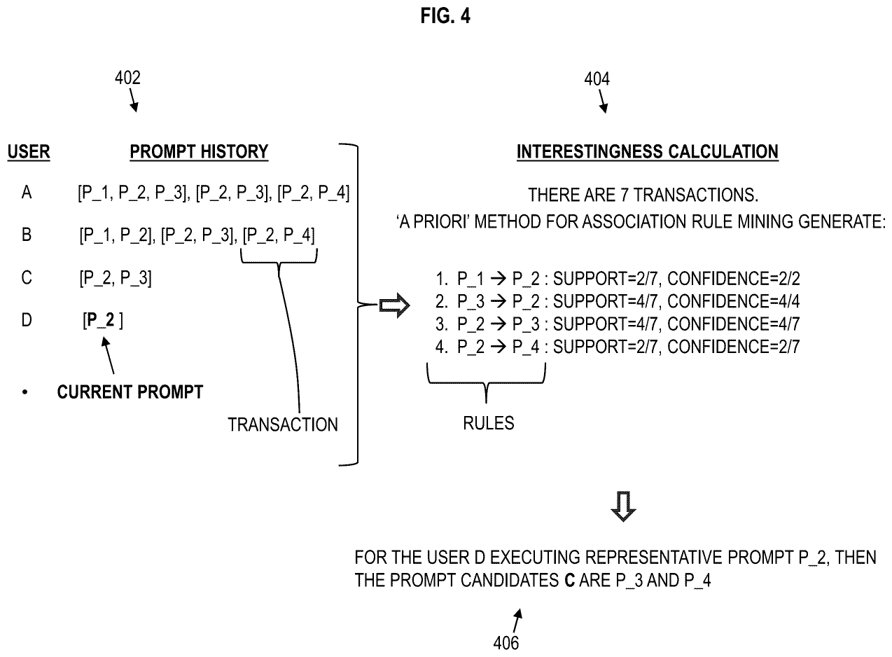

FIG. 4 depicts an example of utilizing prompt history of representative prompts (P) from different users at action 402, determining association rules for representative prompts at action 404, and predicting candidate prompts (C) at action 406 for a given user according to one or more embodiments. In FIG. 4, an example scenario is illustrated for explanation purposes in which there are three users A, B, and C who have previously input prompts that are processed into representative prompts (P). The following example is presented illustrating user prompt history with representative prompts (P) for each of the example users A, B, and C:
User A: [P_1, P_2, P_3], [P_2, P_3], [P_2, P_4], which has 3 transactions.
User B: [P_1, P_2], [P_2, P_3], [P_2, P_4], which has 3 transactions.
User C: [P_2, P_3], which is 1 transaction.

Association rule mining is performed to determine association rules (e.g., association rules in repository 292) based on the combined 7 transactions of user A, user B, and user C. Using the 7 transactions of the representative prompts (P), association rule mining generates the following 4 rules with example support and confidence:
Rule 1: P_1→P_2: Support=2/7, Confidence=2/2.
Rule 2: P_3→P_2: Support=4/7, Confidence=4/4.
Rule 3: P_2→P_3: Support=4/7, Confidence=4/7.
Rule 4: P_2→P_4: Support=2/7, Confidence=2/7.

In the example scenario, the user D has entered/executed a user prompt that may initially have personal information, which has been templatized into a templatized prompt (P), and the templatized prompt (P) is determined to correspond to the representative prompt (P) of a given cluster. The user D has the current representative prompt (P) illustrated as P_2. The software 204 determines that, if the user D executes the current representative prompt P_2, then the candidate prompts (C) are P_3 and P_4. The Rule Interestingness calculation equals the Support * Confidence, which results in: interestingness for P_3=4/7*4/7 while the interestingness for P_4=2/7*2/7.

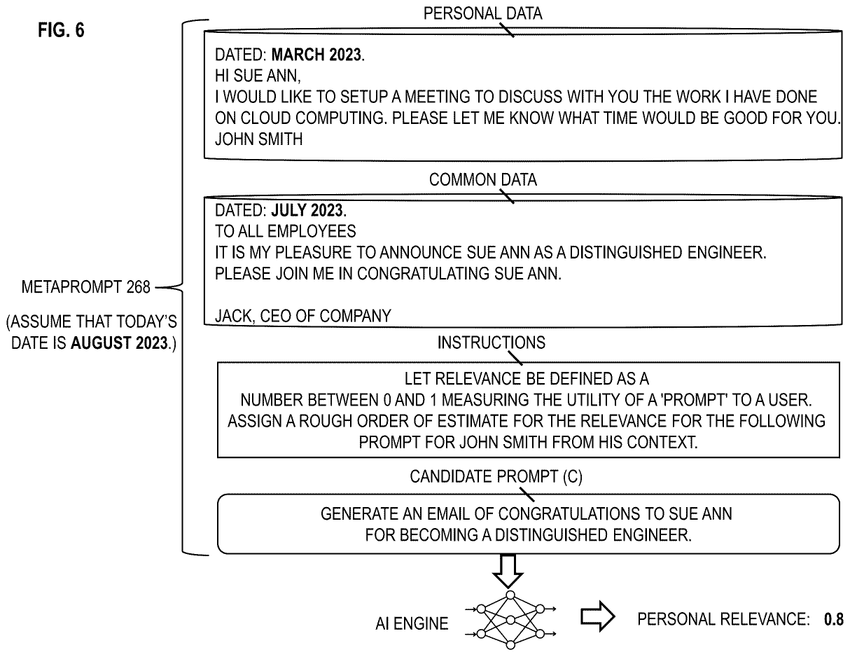

Returning to FIG. 3, at block 310, the software 204 is configured to estimate the personal applicability/relevance for each representative prompt (P) in the candidate prompts (C). The software 204 may retrieve personal information or private data (e.g., from repository 280) of the given user to determine the personal applicability/relevance for each of the candidate prompts (C) and may retrieve common data across an organization (e.g., common data from repository 286). In one or more embodiments, the personal applicability/relevance can be a number between 0 and 1 for each representative prompt (P) in the candidate prompts (C). In one or more embodiments, the personal applicability/relevance=likelihood of consumption (0,1). Continuing the example scenario, the software 204 provides personal applicability/relevance as a value between 0 and 1 for the candidate prompt P_3 and the candidate prompt P_4. As noted above, the candidate prompts P_3 and P_4 are candidates for recommendation to the user D. For explanation purposes, it is assumed that the personal applicability/relevance for the candidate prompt P_3=0.1 and the personal applicability/relevance for the candidate prompt P_4=0.9. As discussed further herein, FIGS. 6, 7, and 8 depict examples of determining the personal applicability/relevance value using a metaprompt in accordance with one or more embodiments.

At block 312, the software 204 is configured to rank the candidate prompts (C) and recommend the ranked candidate prompts (C) to the given user. In one or more embodiments, the software 204 may utilize a ranking formula for each candidate prompt (C): Rule interestingness*Personal applicability/relevance=Ranking score. As noted herein, Rule interestingness=Support*Confidence. The software 204 may choose the top/highest ranked candidate prompt that has not been previously recommended to the given user (e.g., within a given time period).

Continuing the example scenario, the rule interestingness for P_3=4/7*4/7 while the rule interestingness for P_4=2/7*2/7, and the personal applicability/relevance for P_3=0.1 while the personal applicability/relevance for P_4=0.9. Now computing the ranking score for P_3, the ranking score is (4/7*4/7)*0.1=0.033. Now computing the ranking score for P_4, the ranking score is (2/7*2/7)*0.9=0.073. Since the ranking score is higher for the candidate prompt P_4 than the candidate prompt P_3, the software 204 recommends the candidate prompt P_4 to the user of user device 252. In one or more embodiments, the software 204 may rank all the candidate prompts (C) in descending order and/or a predefined number (e.g., the top 2, 3, 4, 5, etc. ,) of the candidate prompts.

Continuing the example scenario, the software 204 causes the candidate prompt (C) to be presented on the user device 252 of the user D. In one or more embodiments, the software 204 can cause the user software 220 of the user device 252 to render the recommended candidate prompt to the user. In one or more embodiments, the software 204 may cause the user device 252 to graphically display the candidate prompt, audibly play the candidate prompt, holographically present the candidate prompt, etc., and/or any combination thereof. In one or more embodiments, the software 204 after receiving an acceptance can cause the candidate prompt to be input to one or more AI engines 244 on behalf of the user and cause output responses from the AI engines 244 to be rendered on the user device 252. For example, the software 204 in communication with use software 252 may receive an acceptance selection from the user, which causes the candidate prompt to be input to the AI engines 244.

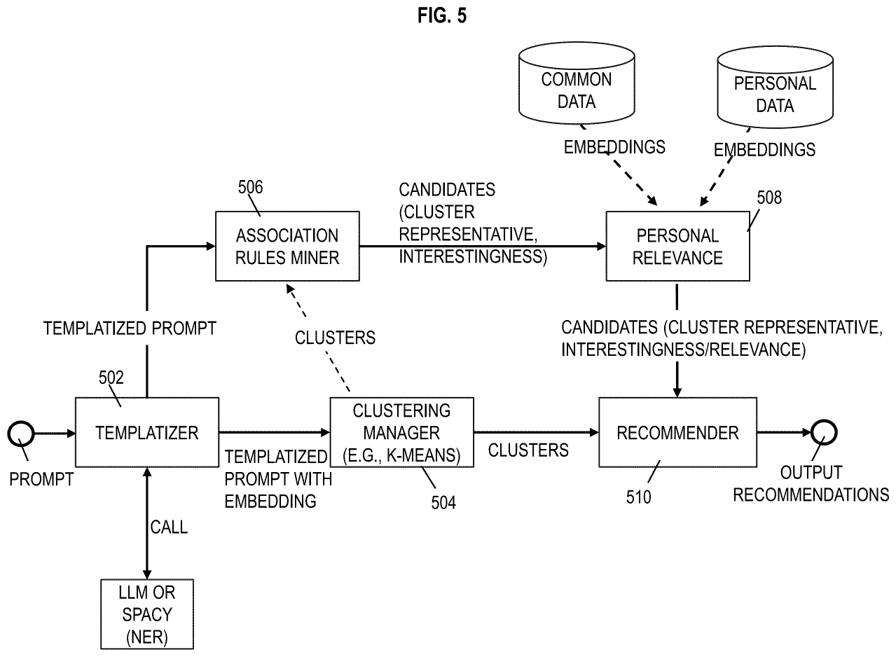

FIG. 5 depicts a block diagram of further example details of the software 204 according to one or more embodiments. In FIG. 5, any user (e.g., such as user D) may enter a prompt with a user device 252, and the templatizer 262 receives the prompt that has personal information. At block 502, the templatizer 262 can employ the LLM 272, an anonymizer (e.g., a Spacy module for NER), etc., to remove personal information from the prompt and output a templatized prompt (T) for association rules mining and output the templatized prompt (T) with embeddings to a clustering algorithm. At block 504, the clustering algorithm 264 determines the appropriate cluster for the templatized prompt with vector embedding. Once the templatized prompt is in a cluster, the cluster representative prompt (P) of the templatized prompt (T) is sent for association rules mining to eventually predict candidate prompts. As noted herein, the cluster representative prompt represents the whole cluster.

At block 506, the association rules miner 266 determines association rules from the past history of user prompts and determines candidate prompts (C) for the cluster representative prompt of the given user. All the templatized prompts for a given user are input to the association rules miner 266 and are replaced with their corresponding cluster representative prompts (P). Using the association rules (e.g., in repository 292), the software 204 can calculate the support and confidence for each association rule and generate candidate prompts (C) that are output to determine personal relevance.

At block 508, the software 204 can use personal data (e.g., personal data in the repository 280) of a given user and common data (e.g., common data in the repository 286) of an organization to determine the personal relevance of a suggested candidate prompt (C) to that user. Personal data may include emails, documents, etc., associated with the user. Common data may include data that is generally related to the organization of which the user is part of. The rule interestingness value for each candidate prompt (C) is received. For each candidate prompt, multiply the rule interestingness and the personal relevance together (e.g., Rule interestingness * Personal relevance=Ranking score) and pass the score to the recommender 270.

At block 510, the recommender 270 ranks the ranking scores for the candidate prompts (C) in decreasing order. The recommender 270 selects the candidate prompt (C) with the highest score, which has not already been suggested to the given user. For example, the recommender 270 can check whether the selected candidate prompt (C) has already been recommended. If not previously recommended, the recommender 270 can recommend the selected candidate prompt (C) with the highest score. If this candidate prompt has previously been recommended, the recommender 270 is configured to select the next candidate prompt (C) with the next highest score as the selected candidate prompt (C).

FIG. 6 depicts a block diagram of an example of determining a personal applicability/relevance for a given candidate prompt (C) using a metaprompt 268 according to one or more embodiment. In FIG. 6, the example metaprompt 268 may include on personal data (e.g., personal data of repository 280) of the user, common data of the organization (e.g., common data of repository 286), instructions for determining the personal applicability/relevance, and the candidate prompt itself. In this example, the user is John Smith. In one or more embodiments, the personal data may include an email from John Smith to Sue Ann dated March 2023. In one or more embodiments, the common data may include an email to all employees from the CEO of the company. In one or more embodiments, the instructions for the AI engine detail how to determine the personal relevance with a score between 0 and 1 for the candidate prompt from the perspective of the user John Smith. In one or more embodiments, the candidate prompt is to generate an email of congratulation to Sue Ann for becoming a distinguished engineer. The software 204 is configured to input the metaprompt 268 to the AI engine 244 and receive a personal applicability/relevance value. In this example, software 204 receives a personal applicability/relevance value of 0.8 from the AI engine 244.

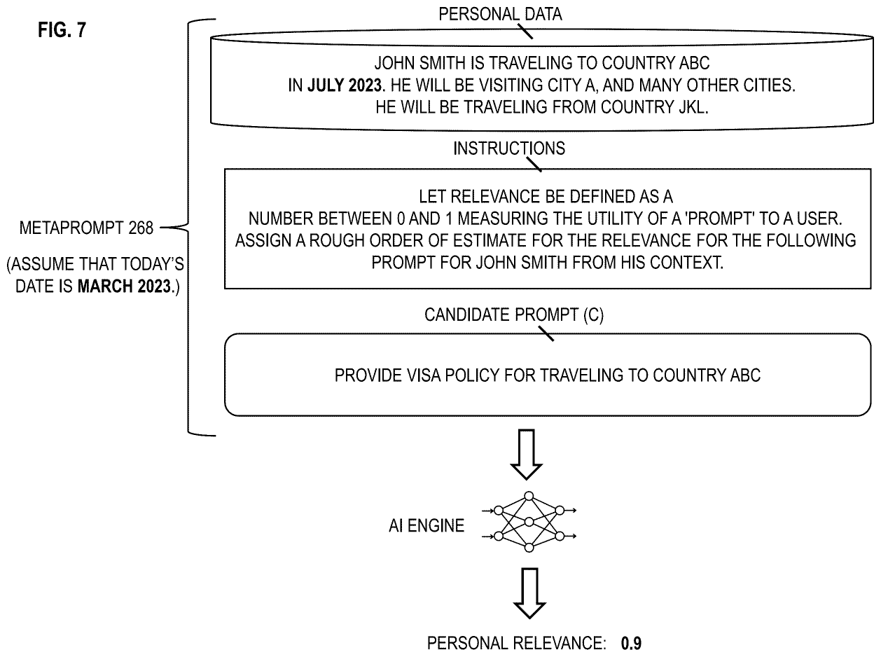

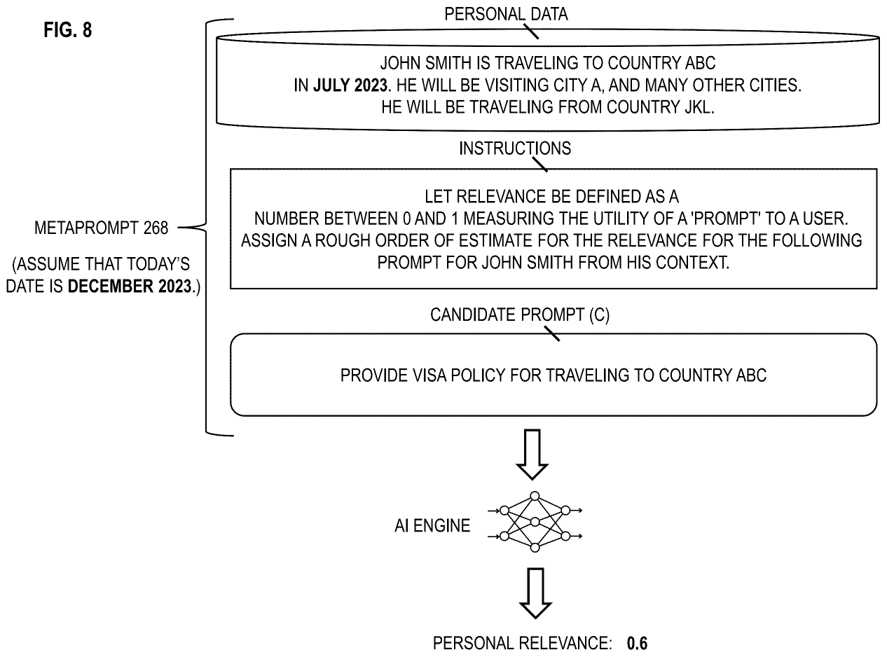

FIG. 7 depicts a block diagram of an example of determining a personal applicability/relevance for a given candidate prompt (C) using a metaprompt 268 according to one or more embodiment. In FIG. 7, the example metaprompt 268 may include on personal data (e.g., personal data of repository 280) of the user, instructions for determining the personal applicability/relevance, and the candidate prompt itself. In this example, the user is John Smith. In one or more embodiments, the personal data may include a document, calendar entry, subject of an email, etc., associated with John Smith, and the personal data includes the date July 2023. Particularly, the date July 2023 is the date of an upcoming trip for John Smith to county ABC. In one or more embodiments, the instructions to the AI engine detail how to determine the personal relevance with a score between 0 and 1 for the candidate prompt from the perspective of the user John Smith. In one or more embodiments, the candidate prompt is to provide a visa policy for traveling to the country ABC. The software 204 is configured to input the metaprompt 268 to the AI engine 244 and receive a personal applicability/relevance value. In this example, the software 204 receives a personal applicability/relevance value of 0.9 from the AI engine 244. In this example, today's date is March 2023 which is the date the metaprompt 268 is input to the AI engine 244. Also, today's date of March 2023 is prior to the date of the trip occurring July 2023; a different example is illustrated in FIG. 8. In one or more embodiments, today's date may be entered in the instructions. Also, the AI engine 244 has knowledge or data of today's date (March 2023) in FIG. 7. In this example of FIG. 7, the AI engine 244 determined/recognized that there is a very high personal relevance for this candidate prompt (C) to John Smith, as evidenced by the personal applicability/relevance value of 0.9. As noted in the example, the lowest value of the personal applicability/relevance can be 0 while the highest value can be 1. In one or more embodiments, other values for the personal applicability/relevance can be requested in the instructions, for example, a value between 0% and 100%.

FIG. 8 depicts a block diagram of an example of determining a personal applicability/relevance for a given candidate prompt (C) using a metaprompt 268 according to one or more embodiment. As noted herein, the example in FIG. 8 is analogous to FIG. 7. However, in FIG. 8, today's date (e.g., December 2023) is subsequent to the data of trip (e.g., July 2023). In FIG. 8, the example metaprompt 268 may include on personal data (e.g., personal data of repository 280) of the user, instructions for determining the personal applicability/relevance, and the candidate prompt itself. In this example, the user is John Smith. In one or more embodiments, the personal data may include a document, calendar entry, subject of an email, etc., associated with John Smith, and the personal data includes the date July 2023. Again, the date July 2023 is the date of a trip for John Smith to county ABC. In one or more embodiments, the instructions to the AI engine detail how to determine the personal relevance with a score between 0 and 1 for the candidate prompt from the perspective of the user John Smith. In one or more embodiments, the candidate prompt is to provide a visa policy for traveling to the country ABC. The software 204 is configured to input the metaprompt 268 to the AI engine 244 and receive a personal applicability/relevance value. In this example, the software 204 receives a personal applicability/relevance value of 0.6 from the AI engine 244. In this example, today's date is December 2023 which is the date the metaprompt 268 is input to the AI engine 244. However, today's date of December 2023 is subsequent to the date of the trip occurring July 2023. Accordingly, the personal applicability/relevance value of the candidate prompt (C) decreased from 0.9 for the example in FIG. 7 to 0.6 for the example in FIG. 8.

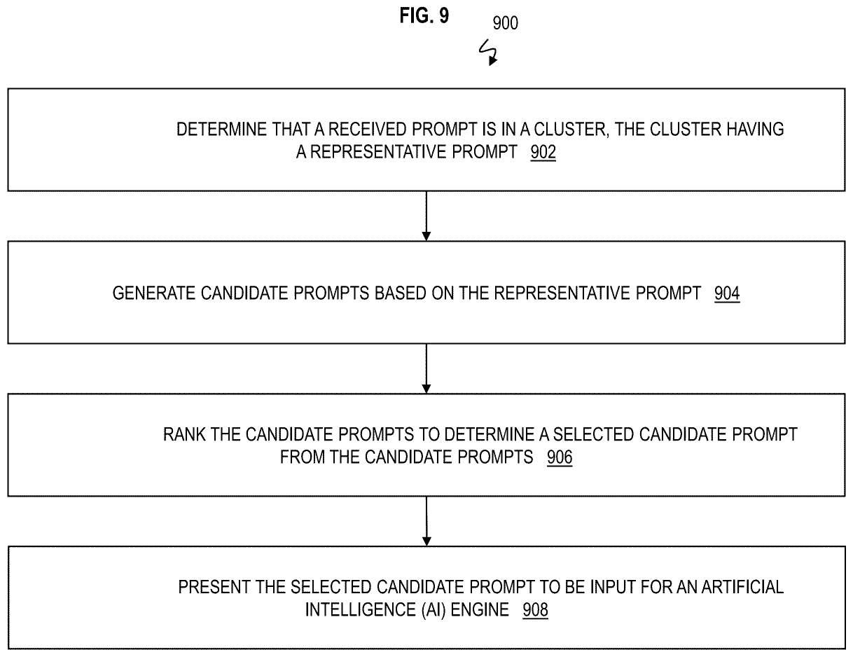

FIG. 9 depicts a flowchart of a computer-implemented method 900 for dynamically (in real-time or near real-time) providing prompt recommendations for AI engines, by determining candidate prompts and presenting the candidate prompts to the user for execution by one or more AI engines according to one or more embodiments.

In one or more embodiments, the computer-implemented method 900 can be executed by the computer system 202 on behalf of and in conjunction with the user device 252. The user device 252 can communicate with the computer system 202 in order to cause the computer system 202 to assist with execution of one or more tasks, for example, in a client server relationship. The computer system 202 can return one or more responses of AI engines to the user device 252 and/or cause one or more responses of AI engines to be returned to the user device 252, for example, by causing the user device 252 to display the responses in a graphical user interface. Reference can be made to any figures discussed herein.

Turning to FIG. 9, at block 902 of the computer-implemented method 900, the software 204 of computer system 202 is configured to determine that a received prompt is in a cluster, the cluster having a representative prompt (e.g., a representative prompt (P)), in response to receiving/capturing/intercepting a user prompt from the user device 252 of the of a user. In one or more embodiments, the user may not enter a prompt, but the software 204 may parse personal data in repository 280 of the user and common data in repository 286 of an organization to determine a representative prompt. At block 904, the software 204 is configured to generate candidate prompts (e.g., candidate prompts (C)) based on the representative prompt (e.g., representative prompt (P)). At block 906, the software 204 is configured to rank the candidate prompts to determine a selected candidate prompt from the candidate prompts. At block 908, the software 204 is configured to present (e.g., on user device 252) the selected candidate prompt to be input for an artificial intelligence (AI) engine (e.g., AI engine 244 of computer system 240).

In one or more embodiments, the generating of the candidate prompts based on the representative prompt comprises predicting the candidate prompts in accordance with association rules (e.g., rules in repository 292). Association rules (e.g., rules in repository 292) for generating the candidate prompts are determined based on a past history of sequences for a plurality of representative prompts. The ranking (e.g., by recommender 270) of the candidate prompts to determine the selected candidate prompt from the candidate prompts comprises scoring the candidate prompts according to a personal relevance (e.g., personal applicability/relevance) and selecting the selected candidate prompt (C) determined to have a top score.

In one or more embodiments, the presenting of the selected candidate prompt to be input for the AI engine 244 comprises causing the selected candidate prompt to be rendered on a user device 252. The software 204 is configured to cause the selected candidate prompt to be input to the AI engine 244. The software 204 is configured to cause an output of the AI engine to be rendered on a user device.

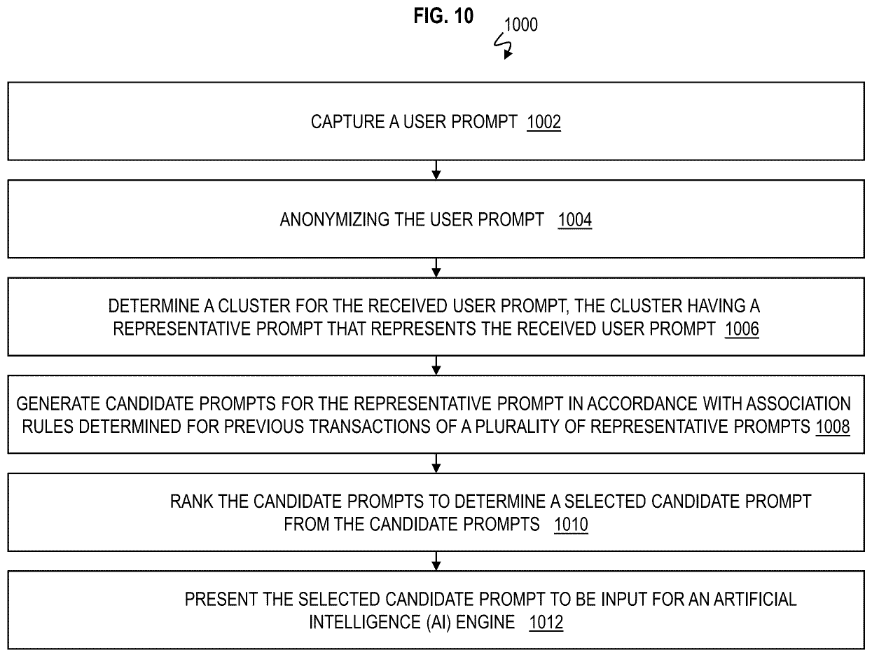

FIG. 10 depicts a flowchart of a computer-implemented method 1000 for dynamically (in real-time or near real-time) providing prompt recommendations for AI engines, by determining candidate prompts and presenting the candidate prompts to the user for execution by one or more AI engines according to one or more embodiments. Reference can be made to any figures discussed herein.

At block 1002 of the computer-implemented method 1000, the software 204 is configured to capture a user prompt. In one or more embodiments, the user prompt may be received from any of the user devices 252. At blocks 1004 and 1006, the software 204 is configured to anonymize the user prompt and determine a cluster for the user prompt, the cluster having a representative prompt that represents the user prompt. In one or more embodiments, personal data of a user can be removed from the user prompt, and the anonymized prompt can be converted into a vector embedding. The vector embedding of the user prompt may be determined to be similar to a cluster having other user prompts out of many other clusters (e.g., clusters in repository 290). The cluster can have a representative prompt (P), for example, having an equal distance or about an equal distance to other user prompts in the cluster. At blocks 1008 and 1010, the software 204 is configured to generate candidate prompts (C) for the representative prompt in accordance with association rules (e.g., in repository 292) determined for previous transactions of a plurality of representative prompts and rank the candidate prompts to determine a selected candidate prompt from the candidate prompts. At block 1012, the software 204 is configured to present the selected candidate prompt to be input for an AI engine (e.g., AI engines 244).

In one or more embodiments, a transaction of the previous transactions of the plurality of representative prompts comprises any two or more representative prompts sequentially occurring within in a predefined window. Example transactions are illustrated in the prompt history of action 402 in FIG. 4. The transaction [P_1, P_2, P_3] denotes that representative prompt P_2 occurs after representative prompt P_1 within the predefined window, and representative prompt P_3 occurs after representative prompt P_2 within the predefined window.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 11, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 11 are intended to be illustrative only and that computing nodes 10 and cloud computing environment 50 can communicate with any type of computerized device over any type of network and/or network addressable connection (e.g., using a web browser).

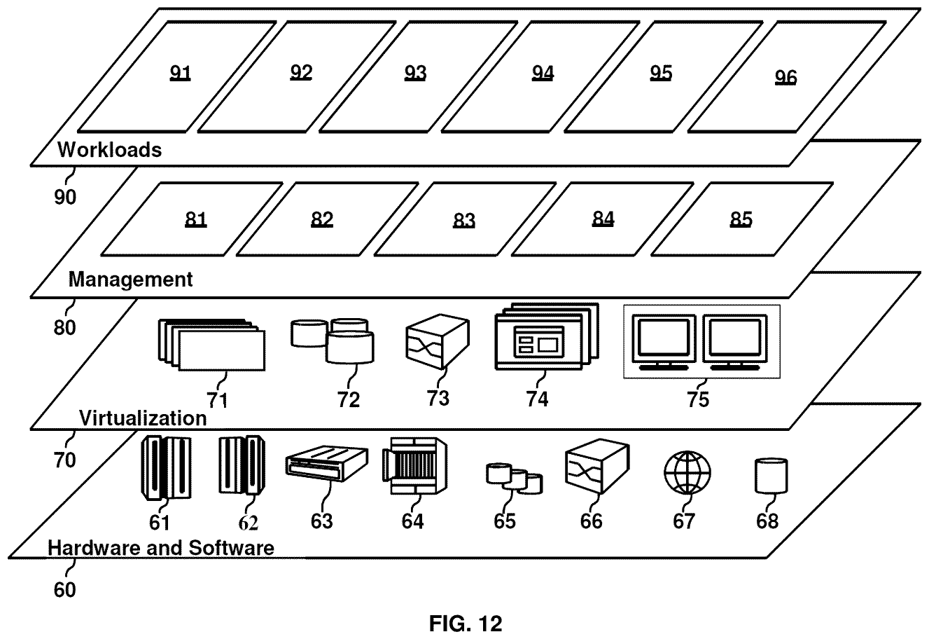

Referring now to FIG. 12, a set of functional abstraction layers provided by cloud computing environment 50 (depicted in FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. One or more aspects of embodiments may be executed, at least in part, by workloads and functions 96. In one or more embodiments, the software 204, templatizer 262, clustering algorithm 264, recommender 270, LLM 272, AI engines 244, etc., can utilize, be executed as, and/or be integrated with workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for the purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagrams or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, e.g., one, two, three, four, etc. The terms “a plurality” are understood to include any integer number greater than or equal to two, e.g., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
determining that a received prompt is in a cluster, the cluster having a representative prompt;
generating candidate prompts based on the representative prompt;
ranking the candidate prompts to determine a selected candidate prompt from the candidate prompts; and
presenting the selected candidate prompt to be input for an artificial intelligence (AI) engine.

2. The computer-implemented method of claim 1, wherein the generating the candidate prompts based on the representative prompt comprises predicting the candidate prompts in accordance with association rules.

3. The computer-implemented method of claim 1, wherein association rules for generating the candidate prompts are determined based on a history of sequences for a plurality of representative prompts.

4. The computer-implemented method of claim 1, wherein the ranking the candidate prompts to determine the selected candidate prompt from the candidate prompts comprises scoring the candidate prompts according to a personal relevance and selecting the selected candidate prompt determined to have a top score.

5. The computer-implemented method of claim 1, wherein the presenting the selected candidate prompt to be input for the AI engine comprises causing the selected candidate prompt to be rendered on a user device.

6. The computer-implemented method of claim 1, further comprising causing the selected candidate prompt to be input to the AI engine.

7. The computer-implemented method of claim 1, further comprising causing an output of the AI engine to be rendered on a user device.

8. A system comprising:
a memory having computer readable instructions; and
one or more processors for executing the computer readable instructions, the computer readable instructions when executed cause the one or more processors to perform operations comprising:
determining that a received prompt is in a cluster, the cluster having a representative prompt;
generating candidate prompts based on the representative prompt;
ranking the candidate prompts to determine a selected candidate prompt from the candidate prompts; and
presenting the selected candidate prompt to be input for an artificial intelligence (AI) engine.

9. The system of claim 8, wherein the generating the candidate prompts based on the representative prompt comprises predicting the candidate prompts in accordance with association rules.

10. The system of claim 8, wherein association rules for generating the candidate prompts are determined based on a history of sequences for a plurality of representative prompts.

11. The system of claim 8, wherein the ranking the candidate prompts to determine the selected candidate prompt from the candidate prompts comprises scoring the candidate prompts according to a personal relevance and selecting the selected candidate prompt determined to have a top score.

12. The system of claim 8, wherein the presenting the selected candidate prompt to be input for the AI engine comprises causing the selected candidate prompt to be rendered on a user device.

13. The system of claim 8, wherein the one or more processors perform the operations further comprising causing the selected candidate prompt to be input to the AI engine.

14. The system of claim 8, wherein the one or more processors perform the operations further comprising causing an output of the AI engine to be rendered on a user device.

15. A computer program product comprising a computer readable storage medium having program instructions embodied therewith, the program instructions executable by one or more processors to cause the one or more processors to perform operations comprising:
determining that a received prompt is in a cluster, the cluster having a representative prompt;
generating candidate prompts based on the representative prompt;
ranking the candidate prompts to determine a selected candidate prompt from the candidate prompts; and
presenting the selected candidate prompt to be input for an artificial intelligence (AI) engine.

16. The computer program product of claim 15, wherein the generating the candidate prompts based on the representative prompt comprises predicting the candidate prompts in accordance with association rules.

17. The computer program product of claim 15, wherein association rules for the candidate prompts are determined based on a history of sequences for a plurality of representative prompts.

18. The computer program product of claim 15, wherein the ranking the candidate prompts to determine the selected candidate prompt from the candidate prompts comprises scoring the candidate prompts according to a personal relevance and selecting the selected candidate prompt determined to have a top score.

19. The computer program product of claim 15, wherein the presenting the selected candidate prompt to be input for the AI engine comprises causing the selected candidate prompt to be rendered on a user device.

20. The computer program product of claim 15, further comprising causing the selected candidate prompt to be input to the AI engine.

21. A computer-implemented method comprising:
capturing a user prompt;
anonymizing the user prompt;
determining a cluster for the user prompt, the cluster having a representative prompt that represents the user prompt;
generating candidate prompts for the representative prompt in accordance with association rules determined for previous transactions of a plurality of representative prompts;
ranking the candidate prompts to determine a selected candidate prompt from the candidate prompts; and
presenting the selected candidate prompt to be input for an artificial intelligence (AI) engine.

22. The computer-implemented method of claim 21, wherein a transaction of the previous transactions of the plurality of representative prompts comprises any two or more representative prompts sequentially occurring within in a predefined window.

23. The computer-implemented method of claim 21, wherein the ranking the candidate prompts to determine the selected candidate prompt from the candidate prompts comprises scoring the candidate prompts according to a personal relevance and selecting the selected candidate prompt determined to have a top score.

24. The computer-implemented method of claim 21, further comprising causing the selected candidate prompt to be input to the AI engine; and
causing an output of the AI engine to be rendered on a user device.

25. A system comprising:
a memory having computer readable instructions; and
one or more processors for executing the computer readable instructions, the computer readable instructions when executed cause the one or more processors to perform operations comprising:
capturing a user prompt;
anonymizing the user prompt;
determining a cluster for the user prompt, the cluster having a representative prompt that represents the user prompt;
generating candidate prompts for the representative prompt in accordance with association rules determined for previous transactions of a plurality of representative prompts;
ranking the candidate prompts to determine a selected candidate prompt from the candidate prompts; and
presenting the selected candidate prompt to be input for an artificial intelligence (AI) engine.
